(19) United States
(12) Patent Application Publication
(10) Pub. No.: US 2026/0353086 A1
(43) Pub. Date: Nov. 5, 2026

(54) DEVICE AND METHOD FOR PROTECTING FRAME IN WIRELESS LOCAL AREA NETWORK

(71) Applicant: FRONTSIDE LLC, Seoul (KR)

(72) Inventor: Jeong Soo LEE, Gyeonggi-do (KR)

(21) Appl. No.: 19/124,467

(22) PCT Filed: Oct. 12, 2023
(86) PCT No.: PCT/KR2023/015720

§ 371 Date: Apr. 25, 2025

(30) Foreign Application Priority Data
Oct. 28, 2022 (KR) 10-2022-0140822
Jul. 20, 2023 (KR) 10-2023-0094665
Aug. 3, 2023 (KR) 10-2023-0101568
Aug. 22, 2023 (KR) 10-2023-0109490

(51) Int. Cl. H04W 12/106; H04L 1/00; H04W 84/12

(52) U.S. Cl. CPC H04W 12/106; H04L 1/0061; H04W 84/12

(57) ABSTRACT

A device for a wireless local area network generates a Quality of Service (QoS) Null frame including a medium access control (MAC) header. The QoS Null frame includes a protection field indicating that the QoS Null frame includes integrity check information to calculate message integrity check (MIC) for protecting an integrity of a part or all of the MAC header.

### TECHNICAL FIELD

The present disclosure relates to a wireless local area network (WLAN), and more particularly, to a method for protecting a frame in the WLAN and a device using the same.

### BACKGROUND ART

A wireless local area network (WLAN) may be formed by one or more access points (APs) that provide a shared wireless communication medium for use by a number of client devices [symbol] so referred to as stations (STAs).

Orthogonal frequency division multiple access (OFDMA) is a multiple access scheme where different subsets of subcarriers are allocated to different users, and this scheme allows simultaneous data transmission to or from one or more users.

A physical layer protocol data unit (PPDU) is a data unit (or data packet) to carry various information in the WLAN. In OFDMA, users are allocated different subsets of subcarriers that can change from one PPDU to the next. Using OFDMA, an AP may allocate different RUs for STAs. The AP can simultaneously transmit various formats of PPDUs to multiple STAs.

Message Integrity Check (MIC) prevents attacks on encrypted packets called bit-flip attacks. During a bit-flip attack, an intruder intercepts an encrypted message, alters it slightly, and retransmits it, and the receiver accepts the retransmitted message as legitimate. The MIC, implemented on both the AP and all associated STAs, can add a few bytes to each packet to make the packets tamper-proof.

### DISCLOSURE OF INVENTION

### Technical Problem

The present disclosure provides a method for protecting a frame in a wireless local area network.

The present disclosure further provides a device for protecting a frame in a wireless local area network.

### Solution to Problem

In an aspect, a method for protecting a frame in a wireless local area network is provided. The method includes generating a Quality of Service (QoS) Null frame to inform an access point that the station changes the station's power management mode, and transmitting the QoS Null frame. The QoS Null frame including a medium access control (MAC) header. The QoS Null frame includes a protection field indicating that the QoS Null frame includes integrity check information to calculate message integrity check (MIC) for protecting an integrity of a part or all of the MAC header.

In another aspect, a device for a wireless local area network includes a processor, and a memory operatively coupled with the processor and configured to store instructions that, when executed by the processor, cause the device to perform functions. The functions include generating a Quality of Service (QoS) Null frame to inform an access point that the device changes the device's power management mode, and transmitting the QoS Null frame. The QoS Null frame includes a medium access control (MAC) header. The QoS Null frame includes a protection field indicating that the QoS Null frame includes integrity check information to calculate message integrity check (MIC) for protecting an integrity of a part or all of the MAC header.

### Advantageous Effects of Invention

As new WLAN communication protocols enable enhanced features, new PPDU transmission designs are provided to support signaling regarding features and resource allocations.

### BRIEF DESCRIPTION OF DRAWINGS

FIG. 1 shows a block diagram of an example wireless communication network.

FIG. 2 shows a block diagram of an example wireless communication device.

FIG. 3 shows an example of UL MU transmission.

FIG. 4 shows an example of multi-link operation.

FIG. 5 shows an example of an enhanced multi-link single radio operation.

IG. 6 shows an example of contents in EML Operating Mode Notification frame.

FIG. 7 shows an example of MAC frame format.

FIG. 8 shows an example of EMLSR operation according to an embodiment of the present disclosure.

FIG. 9 shows another example of EMLSR operation according to an embodiment of the present disclosure.

FIG. 10 shows still another example of EMLSR operation according to an embodiment of the present disclosure.

FIG. 11 shows an example of cross link power management according to an embodiment of the present disclosure.

FIG. 12 shows another example of cross link power management according to an embodiment of the present disclosure.

FIG. 13 shows an example of MAC frame format according an embodiment of the present disclosure.

FIG. 14 shows an example of attack in the power management.

FIG. 15 shows an example of control response protection according to an embodiment of the present disclosure.

FIG. 16 shows an example of MAC Header protection according to an embodiment of the present disclosure.

FIG. 17 shows an example of MAC Header protection according to an embodiment of the present disclosure.

### MODE FOR THE INVENTION

The following description is directed to certain implementations for the purposes of describing innovative aspects of this disclosure. However, a person having ordinary skill in the art will readily recognize that the teachings herein can be applied in a multitude of different ways. The described implementations can be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described implementations can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), single-user (SU) multiple-input multiple-output (MIMO) and multi-user (MU) MIMO. The described implementations also can be implemented using other wireless communication protocols or RF signals suitable for use in one or more of a wireless personal area network (WPAN), a wireless local area network (WLAN), a wireless wide area network (WWAN), or an internet of things (IOT) network.

OFDMA is an OFDM-based multiple access scheme where different subsets of subcarriers are allocated to different users, and this scheme allows simultaneous data transmission to or from one or more users. In OFDMA, users are allocated different subsets of subcarriers that can change from one PPDU to the next. Similar to OFDM, OFDMA employs multiple subcarriers, but the subcarriers are divided into several groups where each group is referred to as a resource unit (RU).

A physical layer protocol data unit (PPDU) may span one or more subchannels and may include a preamble portion and a data portion. Signaling refers to control fields or information in the preamble portion that can be used by a wireless communication device to interpret another field or portion of the preamble portion or the data portion of the PPDU. A wireless channel may be formed from multiple subchannels. A subchannel may include a set of subcarriers. Portions of the wireless channel bandwidth can be divided or grouped to form different resource units (RUs). An RU may be a unit for resource allocation and may include one or more subcarriers. Among other things, a preamble portion of a PPDU may include signaling to indicate which RUs are allocated to different devices. Other types of signaling include indicators regarding which subchannels include further signaling or which subchannels may be punctured. There are several formats of PPDUs (and related structures) defined for current wireless communication protocols. As new wireless communication protocols enable enhanced features, new preamble designs are needed support signaling regarding features and resource allocations. Furthermore, it desirable to define a new preamble signaling protocol that can support future wireless communication protocols.

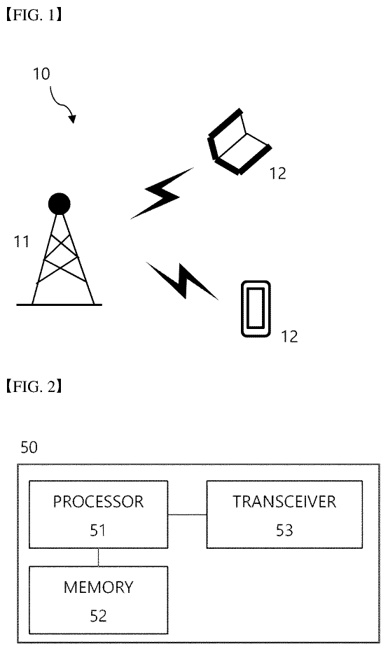

FIG. 1 shows a block diagram of an example wireless communication network.

According to some aspects, the wireless communication network 10 can be an example of a wireless local area network (WLAN) such as a Wi-Fi network (and will hereinafter be referred to as WLAN 10). For example, the WLAN 10 can be a network implementing at least one of the IEEE 802.11 family of wireless communication protocol standards (such as that defined by the IEEE 802.11-2016 specification or amendments thereof including, but not limited to, 802.11ah, 802.11ad, 802.11ay, 802.11ax, 802.11az, 802.11ba and 802.11be). The WLAN 10 may include numerous wireless communication devices such as an access point (AP) 11 and multiple stations (STAs) 12. While only one AP 11 is shown, the WLAN network 10 also can include multiple APs.

Each of the STAs 12 also may be referred to as a mobile station (MS), a mobile device, a mobile handset, a wireless handset, an access terminal (AT), a user equipment (UE), a subscriber station (SS), or a subscriber unit, among other possibilities. The STAs 12 may represent various devices such as mobile phones, personal digital assistant (PDAs), other handheld devices, netbooks, notebook computers, tablet computers, laptops, display devices (for example, TVs, computer monitors, navigation systems, among others), music or other audio or stereo devices, remote control devices (“remotes”), printers, kitchen or other household appliances, key fobs (for example, for passive keyless entry and start (PKES) systems), among other possibilities.

A single AP 11 and an associated set of STAs 12 may be referred to as a basic service set (BSS), which is managed by the respective AP 11. The BSS may be identified to users by a service set identifier (SSID), as well as to other devices by a basic service set identifier (BSSID), which may be a medium access control (MAC) address of the AP 11. The AP 11 periodically broadcasts beacon frames (“beacons”) including the BSSID to enable any STAs 12 within wireless range of the AP 11 to “associate” or re-associate with the AP 11 to establish a respective communication link (hereinafter also referred to as a “Wi-Fi link”), or to maintain a communication link, with the AP 11. For example, the beacons can include an identification of a primary channel used by the respective AP 11 as well as a timing synchronization function for establishing or maintaining timing synchronization with the AP 11. The AP 11 may provide access to external networks to various STAs 12 in the WLAN via respective communication link.

To establish a communication link with an AP 11, each of the STAs 12 is configured to perform passive or active scanning operations (“scans”) on frequency channels in one or more frequency bands (for example, the 2.4 GHz, 5 GHz, 6 GHz or 60 GHz bands). To perform passive scanning, a STA 12 listens for beacons, which are transmitted by respective APs 11 at a periodic time interval referred to as the target beacon transmission time (TBTT) (measured in time units (TUs) where one TU may be equal to 1024 microseconds (μs)). To perform active scanning, a STA 12 generates and sequentially transmits probe requests on each channel to be scanned and listens for probe responses from APs 11. Each STA 12 may be configured to identify or select an AP 11 with which to associate based on the scanning information obtained through the passive or active scans, and to perform authentication and association operations to establish a communication link with the selected AP 11. The AP 11 assigns an association identifier (AID) to the STA 12 at the culmination of the association operations, which the AP 11 uses to track the STA 104.

In some cases, STAs 12 may form networks without APs 11 or other equipment other than the STA. One example of such a network is an ad hoc network (or wireless ad hoc network). Ad hoc networks may alternatively be referred to as mesh networks or peer-to-peer (P2P) networks. In some cases, ad hoc networks may be implemented within a larger wireless network such as the WLAN 10. In such implementations, while the STAs 12 may be capable of communicating with each other through the AP 11 using communication links, STAs 12 also can communicate directly with each other via direct wireless links. Additionally, two STAs 12 may communicate via a direct communication link regardless of whether both STAs 12 are associated with and served by the same AP 11. In such an ad hoc system, one or more of the STAs 12 may assume the role filled by the AP 11 in a BSS. Such a STA may be referred to as a group owner (GO) and may coordinate transmissions within the ad hoc network.

The AP 11 and STAs 12 may function and communicate (via the respective communication links) according to the IEEE 802.11 family of wireless communication protocol standards (such as that defined by the IEEE 802.11-2016 specification or amendments thereof including, but not limited to, 802.11ah, 802.11ad, 802.11ay, 802.11ax, 802.11az, 802.11ba and 802.11be). These standards define the WLAN radio and baseband protocols for the PHY and medium access control (MAC) layers. The AP 11 and STAs 12 transmit and receive wireless communications (hereinafter also referred to as “Wi-Fi communications”) to and from one another in the form of PPDUs. The AP 11 and STAs 12 in the WLAN 10 may transmit PPDUs over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. Some implementations of the AP 11 and STAs 12 described herein also may communicate in other frequency bands, such as the 6 GHz band, which may support both licensed and unlicensed communications. The AP 11 and STAs 12 also can be configured to communicate over other frequency bands such as shared licensed frequency bands, where multiple operators may have a license to operate in the same or overlapping frequency band or bands.

Each of the frequency bands may include multiple channels (which may be used as subchannels of a larger bandwidth channel). For example, PPDUs conforming to the IEEE 802.11n, 802.11ac and 802.11ax standard may be transmitted over the 2.4 and 5 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 or 320 MHz by bonding together multiple 20 MHz channels (which may be referred to as subchannels).

Each PPDU is a composite structure that includes a PHY preamble and a payload in the form of a PHY service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a first portion (or “legacy preamble”) and a second portion (or “non-legacy preamble”). The first portion may be used for packet detection, automatic gain control and channel estimation, among other uses. The first portion also may generally be used to maintain compatibility with legacy devices as well as non-legacy devices. The format of, coding of, and information provided in the second portion of the preamble is based on the particular IEEE 802.11 protocol to be used to transmit the payload.

Uplink (UL) means that the signal (or message or PPDU) is transmitted by a STA to an AP, and downlink (DL) means that the signal (or message or PPDU) is transmitted by the AP to one or more STAs.

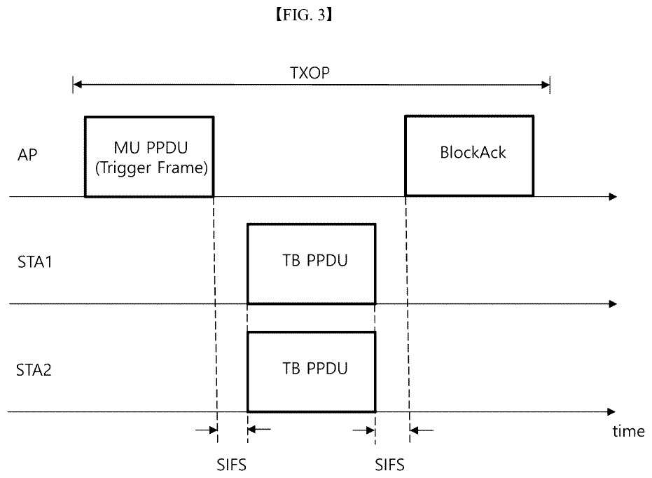

FIG. 2 shows a block diagram of an example wireless communication device.

In some implementations, the wireless communication device 50 can be an example of a device for use in a STA such as one of the STAs 12 described above with reference to FIG. 1. In some implementations, the wireless communication device 50 can be an example of a device for use in an AP such as the AP 11 described above with reference to FIG. 1. The wireless communication device 50 is capable of transmitting (or outputting for transmission) and receiving wireless communications (for example, in the form of wireless packets). For example, the wireless communication device can be configured to transmit and receive packets in the form of PPDUs and/or medium access control (MAC) protocol data units (MPDUs) conforming to an IEEE 802.11 wireless communication protocol standard, such as that defined by the IEEE 802.11-2016 specification or amendments thereof including, but not limited to, 802.11ah, 802.11ad, 802.11ay, 802.11ax, 802.11az, 802.11ba and 802.11be.

The wireless communication device 50 can be, or can include, a chip, system on chip (SoC), chipset, package or device that includes one or more processor 51. The processor 51 can include an intelligent hardware block or device such as, for example, a processing core, a processing block, a central processing unit (CPU), a micro-processor, a microcontroller, a digital signal processor (DSP), an application-specific integrated circuit (ASIC), a programmable logic device (PLD) such as a field programmable gate array (FPGA), discrete gate or transistor logic, discrete hardware components, or any combination thereof designed to perform the functions described herein. The processor 51 processes information received through a transceiver 53, and processes information to be output through the transceiver 53 through the wireless medium. For example, the processor 806 may implement a physical (PHY) layer and/ or a MAC layer configured to perform various operations related to the generation and transmission of PPDUs, MPDUs, frames or packets.

A memory 52 can include tangible storage media such as random-access memory (RAM) or read-only memory (ROM), or combinations thereof. The memory 808 also can store non-transitory processor- or computer-executable software code containing instructions that, when executed by the processor 51, cause the wireless communication device 50 to perform various operations described herein for wireless communication, including the generation, transmission, reception and interpretation of PPDUs, MPDUs, frames or packets. For example, various functions of components disclosed herein, or various blocks or steps of a method, operation, process or algorithm disclosed herein, can be implemented as one or more modules of one or more computer programs.

The transceiver 53 generally includes at least one radio frequency (RF) transmitter (or “transmitter chain”) for transmitting radio signals and at least one RF receiver (or “receiver chain”) for receiving radio signals. For example, the RF transmitters and receivers may include various DSP circuitry including at least one power amplifier (PA) and at least one low-noise amplifier (LNA), respectively. The RF transmitters and receivers may, in turn, be coupled to one or more antennas. For example, in some implementations, the wireless communication device 50 can include, or be coupled with, multiple transmit antennas (each with a corresponding transmit chain) and multiple receive antennas (each with a corresponding receive chain).

Very high throughput (VHT) is used to represent IEEE 802.11ac, high efficiency (HE) is used to represent IEEE 802.11ax, extremely high throughput (EHT) is used to represent IEEE 802.11be. EHT STA may be used to represent a STA supporting at least EHT. EHT STA can further support VHT and/or HE.

‘UHR’ is used to represent any later (post-EHT) version of a new wireless communication protocol conforming to a future IEEE 802.11 wireless communication protocol standard or other standard, and is for illustration purpose only. ‘UHR’ may be referred to as other terms, for example, Ultra Low Latency (ULL), High Reliability (HR), etc. The UHR PPDU may support future amendments to the IEEE 802.11 wireless communication standard.

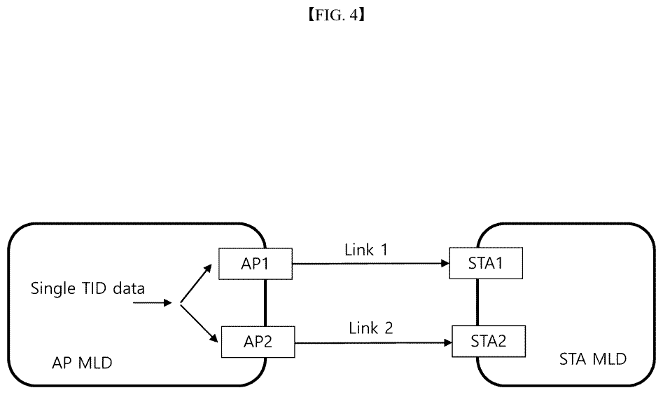

FIG. 3 shows an example of UL MU transmission.

UL MU operation allows an AP to solicit simultaneous immediate response frames from one or more STAs.

The AP may send a trigger frame to one or more STAs (for example, STA1 and STA2). The trigger frame may be sent as MU PPDU (for example, HE MU PPDU or EHT MU PPDU). The STA1 and STA2 may send response PDUs (for example, HE TB PPDU or EHT TB PPDU) in response to the trigger frame. The interframe space between a PPDU that contains a triggering frame and the TB PPDU is a Short Interframe Space (SIFS). The AP sends an Ack or BlockAck frame acknowledging the one or more TB PPDUs to the response STAs (for example, STA1 and STA2).

The trigger frame allocates resources for and solicits one or more PPDU transmissions. The trigger frame also carries other information required by the responding STA to send a TB PPDU or a non-HT PPDU. The trigger frame may be sent as various types such as a basic trigger frame, multi-user request to send (MU-RTS) frame, multi-user block ack request (MU-BAR) frame, Beamforming Report Poll (BFRP) Trigger frame, etc.

The trigger frame may include a UL bandwidth field, an CS required field, one or more STA IDs and one or more resource unit (RU) Allocation field. The UL bandwidth field indicates the bandwidth of the response PPDU. The CS required field indicate whether the response STAs are required to use energy detection (ED) to sense the medium and to consider the medium state and the network allocation vector (NAV) in determining whether or not to respond. The one or more STA IDs identifies the one or more response STAs. The RU Allocation subfield indicates RU allocation for the response PPDU.

A NAV is an indicator, maintained by each STA, of time periods when transmission onto the wireless medium (WM) is not initiated by the STA regardless of whether the STA's clear channel assessment (CCA) function senses that the WM is busy. Transmission opportunity (TXOP) is an interval of time during which a particular STA has the right to initiate frame exchange sequences onto the WM.

A WLAN device classify a received PPDU as an inter-PPDU if (i) the received PPDU is transmitted by an AP which is not associated with the WLAN device, (ii) the received PPDU's BSS is not the BSS of the WLAN device, or (iii) the received PPDU is a downlink MU PPDU and the WLAN device is an AP.

A WLAN device classify a received PPDU as an intra-PPDU if (i) the received PPDU is transmitted by an AP which is associated with the WLAN device, (ii) the received PPDU's BSS is the BSS of the WLAN device, or (iii) the received PPDU is a downlink MU PPDU and the WLAN device is an AP.

Timing synchronization function (TSF) keeps TSF timers for all stations in the same BSS synchronized. STAs can maintain a local TSF timer. Each STA can maintain a TSF timer with modulus 264 counting in increments of microseconds. The AP is the timing master for the TSF. The AP can periodically transmit beacon frames which contain the value of the AP's TSF timer in order to synchronize the TSF timers of other STAs in a BSS. A receiving STA can accept the timing information in the beacon frames and can update the receiving STA's TSF timer. If the receiving STA's TSF timer is different from the timestamp in the received beacon frame, the receiving STA can set its local TSF timer to the received timestamp value.

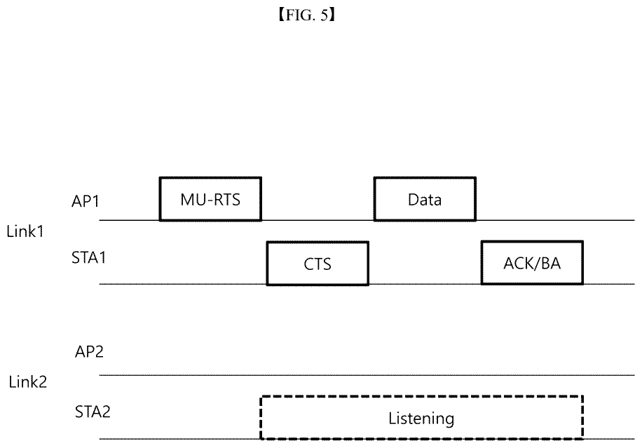

FIG. 4 shows an example of multi-link operation.

In order to optimize the system spectrum utilization and achieve better throughput performance, the IEEE 802.11be has defined multi-link operation (MLO) to support sending data frames concurrently on multiple links. MLO allows the users to enjoy the multilink benefits unavailable for a simple noncontiguous wide spectrum on a single link, such as asynchronous channel access and enhanced power save. The MLO can aggregate a various number of links of different widths. For example, Link1 has a bandwidth of 160 MHz and Link2 has a bandwidth of 40 MHz. Despite having multiple PHY/MAC interfaces, MLD has a single MAC address and uses this MAC address as its own identity. MLO enables frame transmission and retransmission on any link regardless of the link of the initial transmission of the frame.

A multi-link device (MLD) may be a logical entity that is capable of supporting more than one affiliated STA and can operate using one or more affiliated STAs, and that presents one medium access control (MAC) data service and a single MAC-service access point (SAP) to the logical link control (LLC) sublayer. An affiliated AP is an affiliated STA that is an AP STA and the corresponding MLD is an AP MLD. An affiliated STA is a STA, which can be an AP STA or non-AP STA, that provides link-specific, lower MAC and physical layer (PHY) services within an MLD.

An enabled link is a setup link of a non-AP MLD to which at least one traffic identifier (TID) is mapped either in downlink or in uplink. A disabled link is a setup link of a non-AP MLD to which no TID is mapped neither in downlink nor in uplink. A TID is any of the identifiers usable by higher layer entities to distinguish MAC service data units (MSDUs) to MAC entities that support quality of service (QoS) within the MAC data service.

If an MLD implements multiple radios and uses these multiple radios concurrently for the MLO, these devices are defined as multilink multiradio (MLMR) MLD. If an MLD only implements single radio and still wants to operate multiple links, then these devices are called multilink single-radio (MLSR) MLD.

An AP MLD may include multiple APs each capable of communicating on multiple communication links and may establish a BSS on the multiple communication links. A STA MLD may include multiple STAs capable of communicating with other devices (such as an AP MLD) on multiple communication links. If congestion on a first communication link is above a certain level, the MLDs may switch from communicating on the first communication link to communicating on a second communication link. In some implementations, associating with one another on one communication link allows the MLDs to use the same association configuration, encryption keys, and other ML communication parameters when communicating on one or more of the other communication links associated with the MLDs.

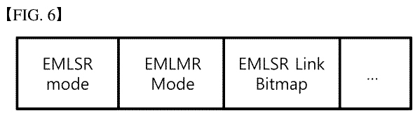

FIG. 5 shows an example of an enhanced multi-link single radio operation.

Enhanced multi-link single radio (EMLSR) operation is a mode of operation that allows a non-AP MLD with multiple receive chains to listen on a set of enabled links when the corresponding STAs affiliated with the non-AP MLD are in the awake state for an initial Control frame (for example, a trigger frame sent by an AP affiliated with an AP MLD, followed by frame exchanges on the link on which the initial Control frame was received).

Assuming that AP MLD includes AP1 and AP2 as affiliated APs, and STA MLD includes STA1 and STA2 as affiliated STAs. When an AP MLD intends to conduct EMLSR operation with an EMLSR STA MLD, each AP within the AP MLD tries to access the corresponding band/channel by running EDCA function independently. In this example, AP1 of the AP MLD is operating on the 6 GHz band (Link1) and AP2 is operating on the 5 GHz band (Link2). If the EDCA function completes the backoff procedure, the corresponding AP starts frame exchange procedure by sending Initial Control Frame (ICF). In this example, AP1 on the 6 GHz band completes backoff, so AP1 sends a MU-RTS frame to start EMLSR operation. When AP1 on the 6 GHz band sends out MU-RTS, STA1 of STA MLD receives the MU-RTS and understands the following DL data transmission which will be carried out on the 6 GHz band.

EMLSR operation can provide throughput enhancement and latency reduction similar to that of concurrent dual-radio MLDs. EMLSR operation enables a wireless device having a single radio to receive data using multiple channels/links. When a wireless device is operating in the EMLSR mode with an AP that supports the EMLSR mode, the device can listen on the enabled links by leaving its affiliated wireless STAs corresponding to those links in an awake state (“listening mode”). The listening operation can include performing clear channel assessment (CCA) and receiving an initial control frame of a frame exchange sequence that is initiated by an AP MLD.

A non-AP MLD may operate in the EMLSR mode on a specified set of the enabled links between the non-AP MLD and its associated AP MLD. The specified set of the enabled links in which the EMLSR mode is applied is called EMLSR links. The EMLSR links can be indicated in the EMLSR Link Bitmap subfield of the EML Control field of the EML Operating Mode Notification frame by setting the bit positions of the EMLSR Link Bitmap subfield to 1. For the EMLSR mode enabled in a single-radio non-AP MLD, the STA(s) affiliated with the non-AP MLD that operates on the link(s) that corresponds to the bit position(s) of the EMLSR Link Bitmap subfield set to 0 may be in doze state if a STA affiliated with the non-AP MLD that operates on one of the EMLSR links is in awake state.

FIG. 6 shows an example of contents in EML Operating Mode Notification frame.

The EML Operating Mode Notification frame is used to indicate that a non-AP MLD with which the transmitting STA is affiliated is changing its EML operation.

A non-AP MLD that supports EMLSR operation sets the EMLSR Mode subfield to 1 to indicate that the non-AP MLD operates in EMLSR mode and to 0 to indicate that the non-AP MLD does not operate in EMLSR mode. The EMLSR Mode subfield is set to 0 if the enhanced multi-link multi-radio (EMLMR) Mode subfield is set to 1. An AP MLD that receives an EML Operating Mode Notification frame from a STA affiliated with a non-AP MLD sets the EMLSR Mode subfield of the EML Operating Mode Notification frame that is sent in response to the value obtained from the received EML Operating Mode Notification frame.

The EMLSR Link Bitmap subfield indicates the subset of the enabled links that is used by the non-AP MLD in the EMLSR mode. The bit position i of the EMLSR Link Bitmap subfield corresponds to the link with the Link ID equal to i and is set to 1 to indicate that the link is used by the non-AP MLD for the EMLSR mode and is a member of the EMLSR links; otherwise the bit position is set to 0.

When a non-AP MLD intends to operate in the EMLSR mode on the EMLSR links, a STA affiliated with the non-AP MLD can transmit an EML Operating Mode Notification frame with the EMLSR Mode subfield of the EML Control field of the frame set to 1 to an AP affiliated with an AP MLD. An AP affiliated with the AP MLD that received the EML Operating Mode Notification frame from the STA affiliated with the non-AP MLD can transmit an EML Operating Mode Notification frame to one of the STAs affiliated with the non-AP MLD within a timeout interval.

When a non-AP MLD is operating in the EMLSR mode with an AP MLD supporting the EMLSR mode, the non-AP MLD can be able to listen on the EMLSR links, by having its affiliated STA(s) corresponding to those links in awake state. The listening operation includes CCA and receiving the initial Control frame of frame exchanges that is initiated by the AP MLD. An AP affiliated with the AP MLD that initiates frame exchanges with the non-AP MLD on one of the EMLSR links can begin the frame exchanges by transmitting the initial Control frame to the non-AP MLD. The initial Control frame may be a MU-RTS Trigger frame or a BSRP Trigger frame. A STA affiliated with a non-AP MLD that is in the listening operation and that receives an MU-RTS Trigger Frame or BSRP Trigger frame addressed to it can respond except when the frame exchanges initiated by the initial Control frame on one of the EMLSR links overlaps with group addressed frame transmissions on the other EMLSR link where the non-AP STA intends to receive the group addressed frames.

After receiving the initial Control frame for initiating frame exchanges and transmitting an immediate response frame as a response to the initial Control frame, a STA affiliated with the non-AP MLD that was listening on the corresponding link can be able to transmit or receive frames on the link in which the initial Control frame was received and cannot transmit or receive on the other EMLSR link(s) until the end of the frame exchanges. The STA affiliated with the non-AP MLD can be capable of receiving a PPDU that is sent using more than one spatial stream on the link in which the initial Control frame was received a SIFS after the end of its response frame transmission solicited by the initial Control frame. During the frame exchanges, the other AP(s) affiliated with the AP MLD may not transmit frames to the other STA(s) affiliated with the non-AP MLD on the other EMLSR link(s).

The AP affiliated with the AP MLD can transmit before the TXNAV timer expires another initial Control frame addressed to the STA affiliated with the non-AP MLD if the AP intends to continue the frame exchanges with the STA and did not receive the response frame from this STA for the most recently transmitted frame that requires an immediate response after a SIFS.

Only one STA affiliated with the non-AP MLD that is operating on one of the EMLSR links may initiate frame exchanges with the AP MLD.

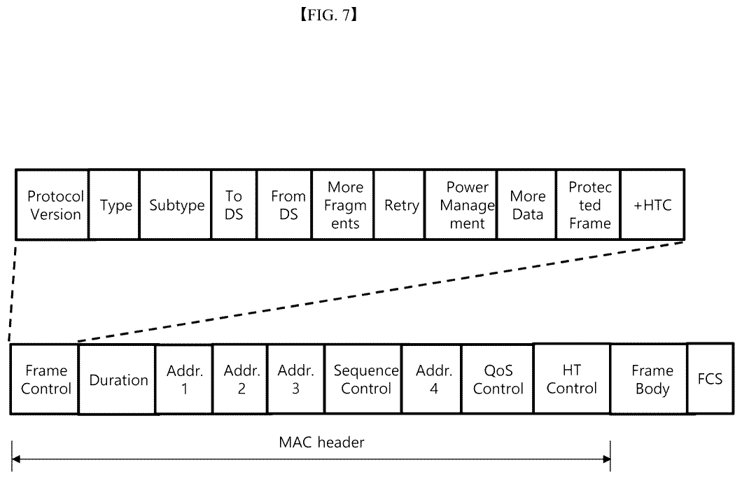

FIG. 7 shows an example of MAC frame format. Not all fields are essential and names of the fields are for illustration purpose only.

A MAC frame contains a MAC header, a Frame Body and a frame check sequence (FCS) field. The frame body contains information specific to the frame type. The FCS field may contain a 32-bit cyclic redundancy check (CRC). The FCS field value may be calculated over all of the fields of the MAC header and the Frame Body field.

The Type and Subtype subfields in the MAC header together identify the function of the frame. There are three frame types: control, data, and management. The More Fragments subfield in Data or Management frames indicates that another fragment of the current MSDU or current MMPDU follows. The Retry subfield indicates that current Data or Management frame is a retransmission of an earlier frame.

The Power Management (PM) subfield is used to indicate the power management mode of a STA. The More Data subfield indicates to a STA in PS mode that more BUS are buffered for that STA at the AP. The More Data subfield is valid in individually addressed Data or Management frames transmitted by an AP to a STA in PS mode.

The More Data subfield indicates that buffered data is present. The Protected Frame subfield indicates that the Frame Body field contains information that has been processed by a cryptographic encapsulation algorithm. +HTC subfield may indicate that the frame contains an HT Control field.

The Duration field (or Duration/ID field) in Data and Management frames may contain a duration for single and multiple protection. In single protection, the Duration field of the frame can set a NAV value at receiving STAs that protects up to the end of any following Data, Management, or response frame plus any additional overhead frames. In multiple protection, the Duration field of the frame can set a NAV that protects up to the estimated end of a sequence of multiple frames.

Hereinafter, power management in WLAN is described.

A non-AP STA can be in one of two power management modes. In active mode, the STA receives and transmits frames at any time if the STA is in awake state. A non-HE STA can remain in the awake state. A HE STA can remain in the awake state, unless the STA is unavailable. A STA that is unavailable is not capable of receiving PPDUs. In power save (PS) mode, the STA enters the awake state to receive or transmit frames. The STA remains in doze state (or sleep state) otherwise.

A STA in PS mode can be in one of two power states. In awake state, the STA is fully powered. In doze state, the STA is not able to transmit or receive PPDUs and consumes very low power. The manner in which a STA transitions between power states is determined by its power management mode.

A STA that is associated with an AP and that changes power management mode can inform the AP of this fact using a Power Management subfield within a Frame Control field of transmitted frames. for example, the Power Management subfield set to 1 indicates that the STA will be in power save mode. The Power Management subfield set to 0 indicates that the STA will be in active mode.

The STA can remain in its current power management mode until the STA informs the AP of a power management mode change via a frame exchange sequence that includes an acknowledgment from the AP. Power management mode does not change during any single frame exchange sequence. This means the Power Management subfield is the same for all MAC protocol data units (MPDUs) in an aggregate-MPDU (A-MPDU). The Power Management subfield may be ignored in frame exchange sequences initiated by the AP.

The AP can buffer individually addressed buffered units addressed to STAS operating in a PS mode. These buffered buffered units can be transmitted only at designated times. A STA that has transmitted a frame to an AP with which it is not associated and from which it expects a response can remain in the awake state until such a response is received or until the procedure has timed out.

To change power management modes a STA can inform the AP by completing a successful frame exchange that is initiated by the STA. This frame exchange sequence can include a Management frame, Extension frame or Data frame from the STA, and an Ack or a BlockAck frame from the AP. The Power Management subfield(s) in the Frame Control field of the frame(s) sent by the STA in this exchange indicates the power management mode that the STA can adopt upon successful completion of the entire frame exchange sequence. A non-AP STA may not change power management mode using a frame exchange sequence that does not receive an Ack or BlockAck frame from the AP, or using a BlockAckReq frame. Since a PS-Poll frame exchange sequence does not necessarily result in an Ack frame from the AP, a non-AP STA cannot change power management mode using the PS-Poll frame.

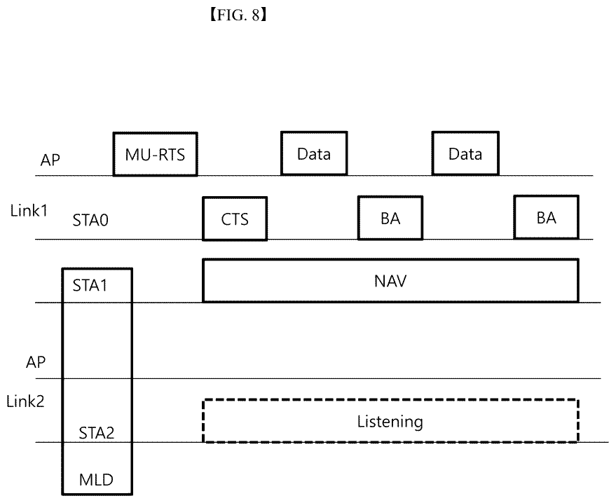

FIG. 8 shows an example of EMLSR operation according to an embodiment of the present disclosure.

STA1 and STA2 are affiliated STAs of STA MLD. The AP sends a MU-RTS as an initial control frame. STAO sends a CTS as a response to the MU-RTS. STA1 which uses same link with STAO sets a NAV based on the received MU-RTS.

A STA can use information from an RTS frame or MU-RTS Trigger frame as the most recent basis to update its NAV setting.

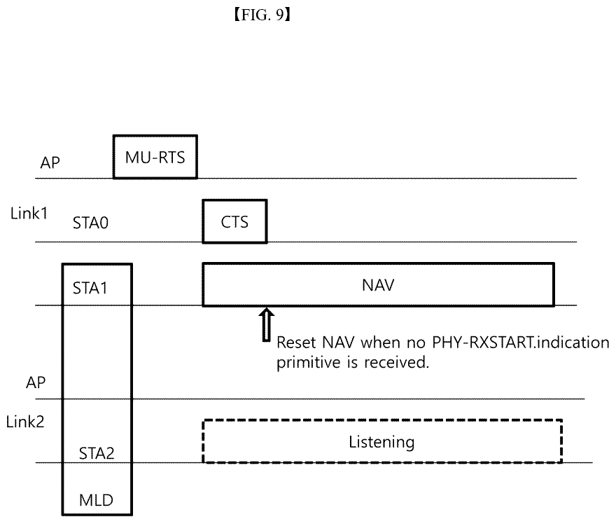

FIG. 9 shows another example of EMLSR operation according to an embodiment of the present disclosure.

STA1 that used information from an RTS frame or MU-RTS Trigger frame as the most recent basis to update its NAV setting is permitted to reset its NAV if no PHY-RXSTART. indication primitive is received from the PHY during a NAVTimeout period starting when the MAC receives a PHY-RXEND. indication primitive corresponding to the detection of the RTS frame or MU-RTS Trigger frame.

The NAVTimeout period may be equal to (2×aSIFSTime)+(CTS_Time)+aRxPHYStartDelay+(2×aSlotTime). If an RTS frame is used for the most recent NAV update, CTS_Time is calculated using the length of the CTS frame and the data rate at which the RTS frame used for the most recent NAV update was received. If an MU-RTS Trigger frame was used for the most recent NAV update, CTS_Time is calculated using the length of the CTS frame and the 6 Mb/s data rate. aRxPHYStartDelay may have the predefined value (for example, 32 us for EHT TB PPDUs).

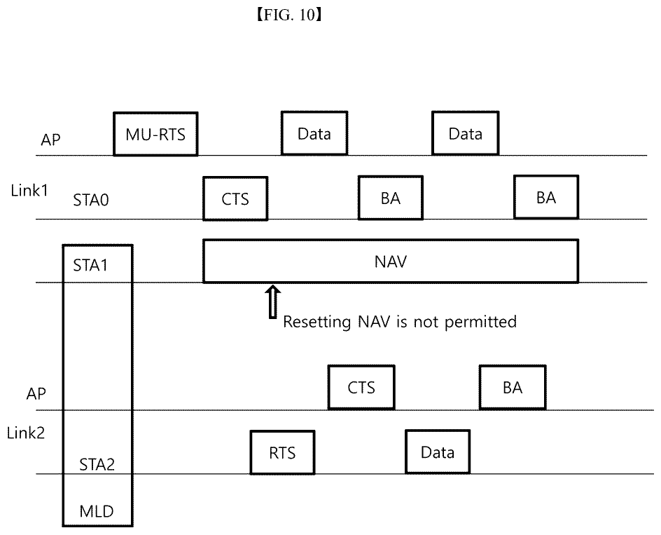

FIG. 10 shows still another example of EMLSR operation according to an embodiment of the present disclosure.

In EMLSR mode, after a STA affiliated with an STA MLD receives an initial Control frame (i.e., MU-RTS) and set its NAV, if the STA affiliated with the STA MLD can't perform a listening operation (i.e., CCA and receiving the initial Control frame of frame exchanges), the resetting NAV is not permitted even though no PHY-RXSTART. indication primitive is received from the PHY during the NAVTimeout period. But, if the STA affiliated with the STA MLD can perform a listening operation during the NAVTimeout period, the resetting NAV is permitted when no PHY-RXSTART. indication primitive is received from the PHY during the NAVTimeout period.

In this example, STA2 of the STA MLD does not perform the listening operation since STA2 sends a RTS as an initial Control frame. STA1 of the STA MLD does not reset the NAV.

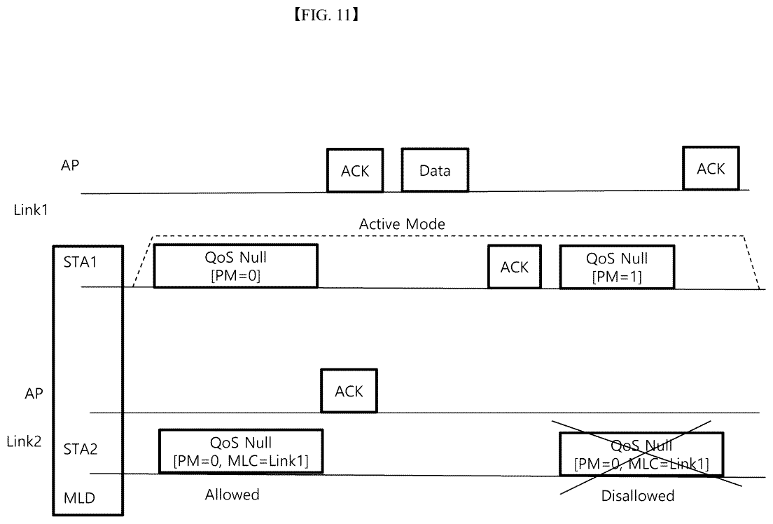

FIG. 11 shows an example of cross link power management according to an embodiment of the present disclosure.

A first STA of STA MLD operating on a first link can change the power management of a second STA of STA MLD operating on a second link. In this example, a QoS Null frame with empty Frame Body field is used to change the power management mode.

Firstly, STA1 of STA MLD sends a QoS Null frame with PM bit set to 0, and STA2 of STA MLD also sends a QoS Null frame with PM bit set to 0 and a Multi-Link Control (MLC) field indicating the Link1. The MLC field indicates a link to which the corresponding PM bit is applied. Since the QoS Null frame of STA1 and the QoS Null frame of STA2 indicates same power management mode on Link1, STA1 is allowed to enter in active mode.

Next, STA1 of STA MLD sends a QoS Null frame with PM bit set to 1, but STA2 of STA MLD sends a QoS Null frame with PM bit set to 0 and the MLC field indicating the Link1. Since the QoS Null frame of STA1 and the QoS Null frame of STA2 does not indicate same power management mode on Link1, STA1 is not allowed to enter in a power save mode.

A STA affiliated with a non-AP MLD may change the power management (e.g., active mode, power save mode) of the STA operating on the other EMLSR link(s) by sending a Multi-Link Control (MLC) A-Control field. In an embodiment, the MLC A-Control field can include a MLC field indicating a link and a PM bit corresponding to the link. In another embodiment, the MLC A-Control field can contain a Link Bitmap field. Each bit of the Link Bitmap field may be mapped to each link: Link bitmap =(Link1, Link2, . . . , Link M). n-th bit of the Link Bitmap represents Link n's power management mode. It is noted that the cross-link power management is not limited to a non-AP MLD operating on the EMLSR mode. Generally, it can be used for all non-AP MLDs.

When a non-AP MLD changes the power management mode (e.g., active mode, power save mode) of a STA operating on the EMLSR link(s), the non-AP MLD may not trigger that more than one affiliated STA simultaneously send frames to change the power management of a single STA affiliated with the non-AP MLD. Especially, a non-AP can avoid that more than one frame simultaneously sent to AP MLD indicates a different power management status for a single STA.

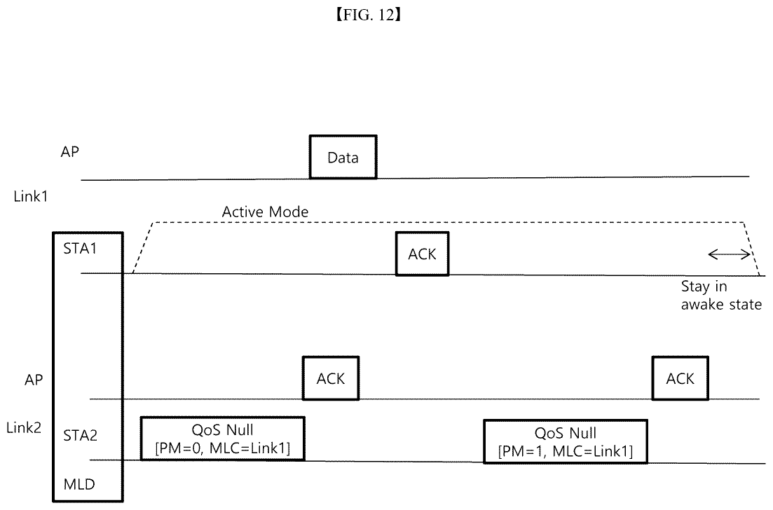

FIG. 12 shows another example of cross link power management according to an embodiment of the present disclosure.

A non-AP MLD changes the power management mode (e.g., active mode, power save mode) of a STA operating on the EMLSR link(s). After a second STA (STA2) affiliated with the non-AP MLD that operates on the second EMLSR link (Link2) sends the MLC A-Control field to change the power management of a first STA (STA1) affiliated with the non-AP MLD that operates on the first EMLSR link (Link1), the first STA (STA1) does not change the power management mode on the first EMLSR link until a timer (called as an MLC Processing Delay timer) is expired. STA1 can change the power management mode after a predefined time. If STA2 indicates same power management mode with the current power management mode of the STA1, STA2 can send a frame to change the power management mode of the STA1 at any time.

After a second STA affiliated with the non-AP MLD that operates on the second EMLSR link changes the power management for the second STA and the second ELMSR link, the first STA affiliated with the non-AP MLD that operates on the first EMLSR link does not send the MLC A-Control field to change the power management mode of the second STA until a timer (e.g., the Multi-Link Control Processing Delay timer) is expired. The first STA can send the MLC A-Control field to change the power management mode of the second STA after a predefined time. If the first STA indicate same power management mode in the MLC A-Control field as current power management mode of the second STA, the first STA can send a frame carrying such MLC A-Control field at any time.

When a non-AP MLD changes the power management mode of a STA operating on the EMLSR link(s), the AP MLD signals to the non-AP MLDs in the Beacon, Probe Response, (Re)Association Response frames a value of the MLC Processing Delay timer, which is the delay time to synchronize the control information among the affiliated APs. If the non-AP MLD intends to send frames for changing the power management mode through other links, the non-AP MLD can start the MLC Processing Delay timer for that STA after sending a frame that triggers to change the power management mode for the specific affiliated STA.

If the power management mode of a STA affiliated with the non-AP MLD is changed through the MLC A-Control field sent by another STA affiliated with the non-AP MLD, the STA can apply the status change of power management mode when the MLC Processing Delay timer is expired. For example, when a non-AP MLD sent the MLC A-Control field to change the power management mode of an affiliated STA to a doze state, the affiliated STA can stay in an awake state until the MLC Processing Delay timer is expired.

Hereinafter, various schemes to protect a frame are proposed.

An attacker may transmit a frame (e.g., QoS Data frame, QoS Null frame, and/or Management frame) having a fake Power Management subfield to an AP on behalf of a victim STA. The fake Power Management subfield inform the AP a fake power management mode of the victim STA. After receiving the fake Power Management subfield, the AP may buffer packets for the victim STA even when the victim STA is in active mode. Or the AP may try to deliver packets to the victim STA while the victim STA is in doze state.

For robust power management, the message integrity check (MIC) of the Power Management subfield in the Frame Control field is required. For MAC header protection, the integrity check of the MAC header in the QoS Data, QoS Null, and/or Management frame is required. Dynamic information (e.g., Duration field) in the MAC header can be masked to 0.

IEEE 802.11 standard defines counter mode (CTR) with cipher-block chaining message authentication code (CBC-MAC) protocol (CCMP) as one of robust security network association (RSNA) to provide data confidentiality, authentication, integrity, and replay protection. CCMP is based on the CTR with CBC-MAC (CCM) of the Advanced Encryption Standard (AES) encryption algorithm. CCM combines CTR for data confidentiality and CBC-MAC for authentication and integrity. CCM can protect the integrity of both the MPDU Data field and selected portions of the IEEE 802.11 MPDU header.

CCM is a generic mode that can be used with any block-oriented encryption algorithm. CCM may have two parameters, M and L. CCMP-128 uses M=8 (indicating that the MIC is 8 octets) and L=2 (indicating that the Length field is 2 octets, which is sufficient to hold the length of the largest possible IEEE 802.11 MPDU, expressed in octets). CCMP-256 uses M=16 (indicating that the MIC is 16 octets), and L=2 (indicating that the Length field is 2 octets, which is sufficient to hold the length of the largest possible IEEE 802.11 MPDU, expressed in octets).

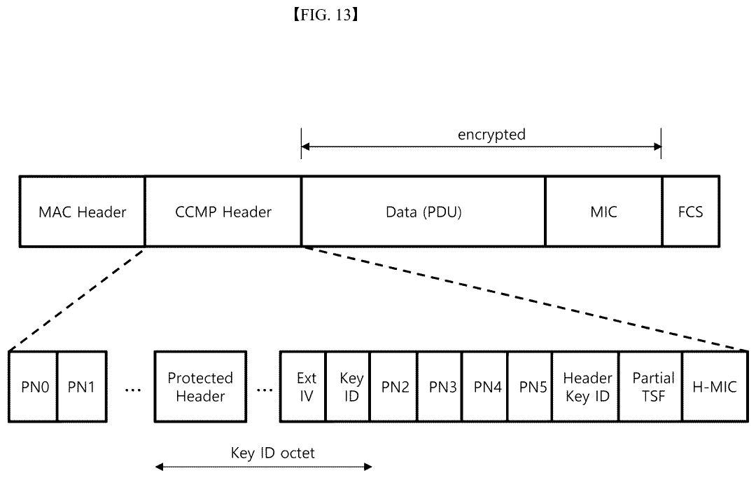

FIG. 13 shows an example of MAC frame format according an embodiment of the present disclosure. A Frame Body field in the MAC frame includes a CCMP Header, Data and MIC.

CCMP-128 processing expands the original MPDU size by 16 octets, 8 octets for the CCMP Header field and 8 octets for the MIC field. CCMP-256 processing expands the original MPDU size by 24 octets, 8 octets for the CCMP Header field, and 16 octets for the MIC field. The CCMP Header field is constructed from packet number (PN), ExtIV, and Key ID subfields. For example, PN is 48-bits PN represented as an array of 6 octets. PN5 is the most significant octet of the PN, and PNO is the least significant.

The ExtIV subfield (for example, bit 5) of the Key ID octet signals that the CCMP Header field extends the MPDU header by a total of 8 octets, compared to the 4 octets added to the MPDU header when Wired equivalent privacy (WEP) is used. The ExtIV bit may always be set to 1 for CCMP.

The CCMP Header in a target frame (e.g., QoS Data, QoS Null, and/or Management frame) may further contain a Protected Header, Header Key ID, a first partial TSF (e.g., TSF timer [6:13]), and Header-MIC (H-MIC). The first partial TSF may include a part of TSF timer value.

The H-MIC of the target frame can be calculated through Cipher-based message authentication code (CMAC)-128 and/or Galois Message Authentication Code (GMAC)-128. CMAC-128 provides data integrity and replay protection using AES-128 in CMAC Mode with a 128-bit integrity key and a CMAC TLen value of 128 (16 octets). The CMAC output for CMAC-128 is truncated to 16 bits: H-MIC=Truncate-16(CMAC Output).

In the MIC calculation, the PN can be generated by concatenating the first partial TSF timer in the first TSF subfield and a second partial TSF which is determined by the STA's local TSF timer. (e.g., [14:53]). For example, PN=PN0∥PN1∥PN2∥PN3∥PN4∥PN5=TSF timer [6:53]. The PN can be generated by concatenating (or combining) at least one of the first partial TSF timer, the second partial TSF, a counter, a link identifier and an additional value.

The MAC header is the input of the MIC calculation. The Power Management subfield may not be masked and may be included in the additional authentication data (AAD) construction. To verify the target frame, the Address 2 field (BSSID) may not be masked and may be included in the AAD construction. The EOSP subfield may not be masked and may be included in the AAD construction.

For QoS Data and Management frame, the Protected Header subfield can be included in the CCMP header. The Protected Header subfield may be one type of a protection field which indicates that the corresponding frame includes integrity check information to calculate MIC for protecting an integrity of a part or all of the corresponding frame (and/or an integrity of a part or all of MAC header in the corresponding frame). Integrity check information may include at least one of the Header Key ID, a partial TSF timer and H-MIC. For example, the Protected Header subfield in the CCMP header is set to a first value (e.g., 1) if the MAC header integrity check information is carried. Otherwise it is set to a second value (e.g., 0).

The Header Key ID can be the same as the Key ID of the encrypted Data. In such cases, the Header Key ID is not carried.

Since QoS Null frame has empty Frame Body filed, integrity check information cannot be carried in the CCMP header. For QoS Null frame, the Protection subfield to indicate that the QoS Null frame includes integrity check information can be included in the Frame Control field of the MAC header. The Protection subfield may be a bit 14 of the Frame Control field or a bit 7 in the QoS Control field. The Protection subfield may set to 1 if the MAC header integrity check information is carried. Otherwise it may be set to 0. For QoS Data and Management frame, the Protection subfield (i.e., the Bit 14 in the Frame Control field) can indicate whether the Data is encrypted or not.

The MAC header integrity check information may include at least one of the Header Key ID, a partial TSF timer and H-MIC. For QoS Null frame, the MAC header integrity check information can be carried between MAC Header and FCS field. For QoS Null frame, FCS value and the MAC header integrity check information can be combined through various schemes (for example, exclusive OR). The MAC header integrity check information can be carried in the FCS field. Different combining function can be applied. For QoS Null frame, the MAC header integrity check information can be carried in the MAC header. The Sequence Control field (2octets) may carry a part or all of the MAC header integrity check information and/or the A-Control field can carry a part of all of the MAC header integrity check information.

A STA affiliated with a non-AP MLD may change the power management (e.g., active mode, power save mode) of the STA operating on the other EMLSR link(s) by sending the MLC A-Control field. In the embodiment of FIG. 11, the MLC A-Control field can also be applied to the integrity check when the cross-link power management is used. In the MIC calculation, the MAC header is the input of the MIC calculation. The MLD A-Control field cannot be masked and may be included in the AAD construction.

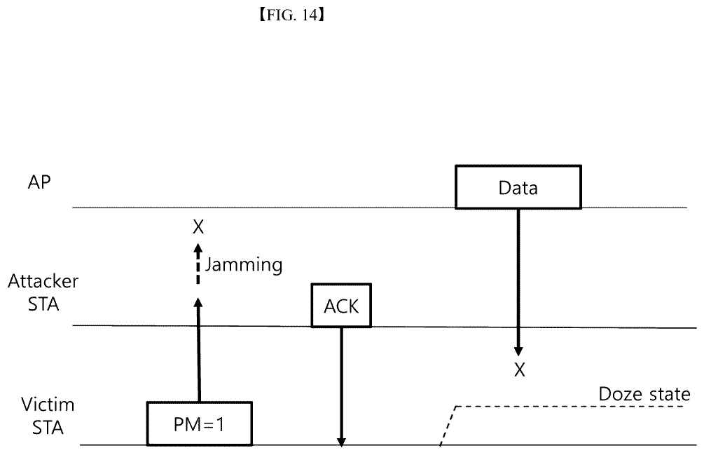

FIG. 14 shows an example of attack in the power management.

A victim STA sends to an AP a target frame (e.g., QoS Data, QoS Null, or Management frame) with a Power Management subfield in the Frame Control field equal to 1 to indicates that the victim STA will be in PS mode. While overhearing that the target frame, the attacker STA makes the AP fail to correctly receive the target frame by transmitting a jamming signal. The attacker STA sends an Ack frame to the victim STA on behalf of the AP. After the victim STA enter into the doze state, the victim STA can't receive a frame sent by the AP.

For robust power management, the integrity check of the Control Response frame (e.g. Ack frame and/or BlockAck frame) is needed. The Control response frame may contain the integrity check information.

For Ack frame, the Protection subfield to indicate that the Ack frame includes the integrity check information can be included in the Frame Control field of the MAC header. The Protection subfield may be a bit 14 of the Frame Control field. The Protection subfield may set to 1 if the integrity check information is carried. Otherwise it may be set to 0. The integrity check information is carried between MAC Header and FCS field. Or, the integrity check information is carried in the FCS field.

When the Ack frame is sent through the Control Wrapper frame, the integrity check information is carried in the A-Control field.

For Block Ack frame, the Protection subfield to indicate that the Block Ack frame includes the integrity check information can be included in the Frame Control field of the MAC header. The Protection subfield may be a bit 14 of the Frame Control field and/or Bit 0 in the BA Control field. The Protection subfield may set to 1 if the integrity check information is carried. Otherwise it may be set to 0.

When the integrity check information is present in the Block Ack frame, the integrity check information is carried in between the BA Information and FCS field.

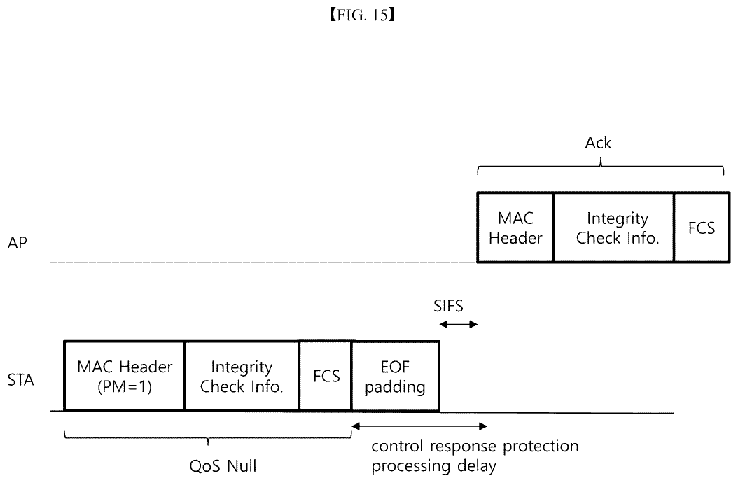

FIG. 15 shows an example of control response protection according to an embodiment of the present disclosure.

A STA can need more processing time to generate the integrity check information. In such case, the STA indicates the control response protection processing delay to a peer STA.

The STA that intends to receive the control response frame (e.g., Ack and Block Ack frames) with the integrity check information can guarantee the control response protection processing delay time in the soliciting frame by using a padding mechanism (e.g., EOF padding).

After receiving the control response frame, if the H-MIC in the control response frame is not matched with the MIC calculated by the soliciting STA, the control response frame may be ignored. It is considered as the transmission failure of the soliciting frame.

In the conventional WLAN, a PPDU synchronous scrambler is used to scramble DATA field, composed of SERVICE, PSDU, tail, and pad parts in a PPDU. The octets of the PSDU are placed in the transmit serial bit stream, bit 0 first and bit 7 last. The PPDU synchronous scrambler uses the generator polynomial S(x), S(x)=x\hat{ }7+x\hat{ }4+1. The same scrambler is used to scramble transmit data and to descramble receive data. A transmitting STA can set the first 7 bits of the scrambling sequence as TXVECTOR parameter SCRAMBLER_INITIAL_VALUE.

During reception, a receiving STA may generate the RXVECTOR parameter SCRAMBLER_INITIAL_VALUE as the integer representation of the first 7 bits of the scrambling sequence, with the first bit of the scrambling sequence being the LSB of the SCRAMBER_INITIAL_VALUE.

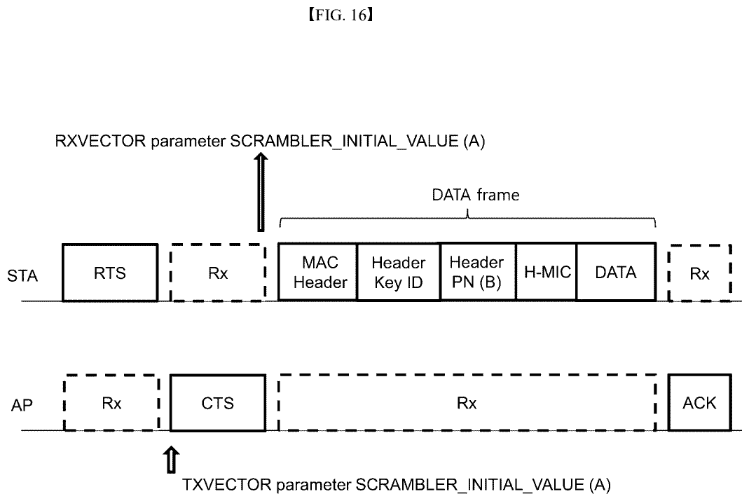

FIG. 16 shows an example of MAC Header protection according to an embodiment of the present disclosure.

A STA that obtains a TXOP sends an RTS frame to an AP. The AP sends a CTS frame to the STA as a response to the RTS frame. Assuming that TXVECTOR parameter SCRAMBLER_INITIAL_VALUE in the CTS frame transmitted by the STA is A. RXVECTOR parameter SCRAMBLER_INITIAL_VALUE in the CTS frame received by the AP is A.

The STA sends a DATA frame with an H-MIC to the AP. Therefore, the PN used for the H-MIC calculation includes the Header PN field value, which is B, and the RXVECTOR parameter SCRAMBLER_INITIAL_VALUE, which is A.

The transmitter can sequentially increase the Header PN field value for each MPDU. The recipient STA sets the TXVECTOR parameter SCRAMBLER_INITIAL_VALUE to a random number.

In the replay detection, the recipient STA only maintains the Header PN field value. If the Header PN field value of a received frame is less than or equal to the latest Header PN field value that the recipient STA maintains, then the frame is discarded.

At the end of the TXOP, the recipient STA resets the SCRAMBLER_INITIAL_VALUE used for the Header MIC calculation. Therefore, another negotiation about SCRAMBLER_INITIAL_VALUE is needed when the TXOP starts.

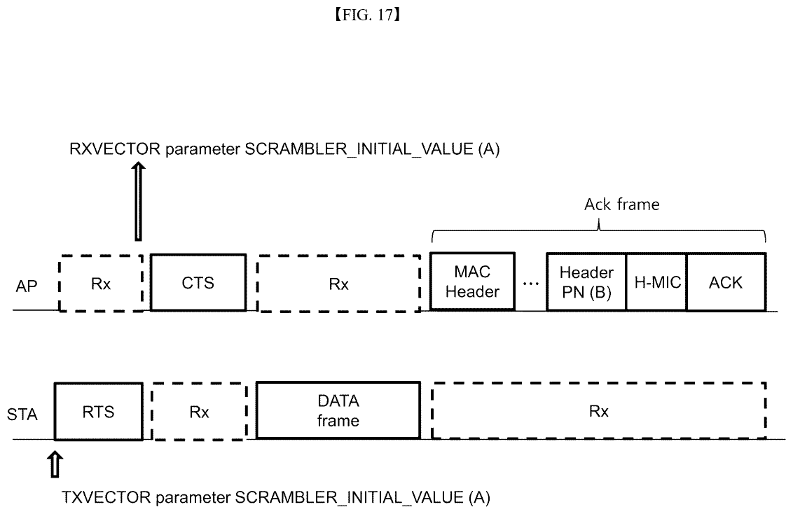

FIG. 17 shows an example of MAC Header protection according to an embodiment of the present disclosure.

An Ack frame (and/or BlockAck frame) contains the integrity check information that may include the Header Key ID, Header PN and H-MIC. The H-MIC of the Ack frame can be calculated through CMAC-128 and/or GMAC-128. In the H-MIC calculation, the PN can be generated by concatenating the Header PN field value carried in the frame with the RXVECTOR parameter SCRAMBLER_INITIAL_VALUE of the (MU)-RTS (and/or BSRP Trigger frame) received from the recipient STA at the beginning or middle of the TXOP. That is, the PN used for the H-MIC calculation includes two parts: the first part is determined by the transmitter, and the second part is determined by the recipient STA.

The MAC header is the input of the H-MIC calculation. To verify the link that Ack frame is transmitted, the Address 1 field (RA) may not be masked and may be included in the AAD construction.

In this example in FIG. 17, a STA that obtains a TXOP sends a RTS frame to an AP. TXVECTOR parameter SCRAMBLER_INITIAL_VALUE in the RTS frame is A.

The AP sends a CTS frame to the STA and receives a DATA frame from the STA. TXVECTOR parameter SCRAMBLER_INITIAL_VALUE in the CTS frame is A.

The AP sends an Ack frame with an H-MIC to the STA. The RXVECTOR parameter SCRAMBLER_INITIAL VALUE in the received RTS frame is A. Therefore, the PN used for the H-MIC calculation includes the Header PN field value, which is B, and the RXVECTOR parameter SCRAMBLER_INITIAL_VALUE, which is A.

The robust MAC header protection can be applied to a termination of TXOP. A TXOP holder is a STA that has either been granted a TXOP by the hybrid coordinator (HC) or successfully contended for a TXOP. A TXOP responder is a STA that transmits a frame in response to a frame received from a TXOP holder during a frame exchange sequence, but that does not acquire a TXOP in the process.

To terminate TXOP, a TXOP holder that transmits a PPDU using one of the modulation classes can transmit a short Control frame as the final transmission in a TXOP. The TXOP responder can verify whether the control response frame is correctly received at the TXOP holder before applying information in the MAC header sent by the TXOP holder. If the TXOP responder does not receive the follow-up frame (e.g., CF-END, CTS-to-self) a SIFS after the control response, then the TXOP responder can assume that the TXOP holder did not receive the control response frame. As a result, the responder can discard the received MAC header information (e.g., the PM subfield).

As used herein, a phrase referring to “at least one of” or “one or more of” a list of items refers to any combination of those item, including single members. For example, “at least one of: a, b, and c” is intended to cover the possibilities of: a only, b only, c only, a combination of a and b, a combination of a and c, a combination of b and c, and a combination of a and b and c.

The various illustrative components, logic, logical blocks, modules, circuits, operations and algorithm processes described in connection with the implementations disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

While operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

1-12. (canceled)

13. A method for protecting a frame in a wireless local area network, the method performed by a transmitting station and comprising:
transmitting a data frame to a receiving station;
in response to the data frame, receiving a BlockAck frame for acknowledging the data frame from the receiving station, the BlockAck frame including:
a protection subfield indicating that the BlockAck frame is protected,
key information indicating an integrity key,
packet number (PN) information used to determine a PN corresponding to the integrity key indicated by the key information, and
message integrity check (MIC) information indicating a first MIC calculated over the BlockAck frame;
computing a second MIC based on the BlockAck frame; and
verifying the BlockAck frame based on the first MIC and the second MIC.

14. The method of claim 13, wherein the data frame includes padding bits to guarantee a processing delay time during which the receiving station generates the MIC to protect the BlockAck frame.

15. The method of claim 13, wherein verifying the BlockAck frame based on the first MIC and the second MIC includes:
discarding the BlockAck frame when the first MAC does not match with the second MIC.

16. The method of claim 13, wherein the protection subfield in the BlockAck frame is set to 1 when the protection subfield indicates that the BlockAck frame is protected.

17. The method of claim 13, wherein the protection subfield is present in a BlockAck control field in the BlockAck frame, and the PN information and the MIC information are carried in between the BlockAck control field and a frame check sequence (FCS) field of the BlockAck frame.

18. The method of claim 13, wherein the PN information and the MIC information are not present in the BlockAck frame when the protection present subfield in the Block Ack frame does not indicate that the BlockAck frame is protected.

19. The method of claim 13, wherein the second MIC is computed over the BlockAck frame based on the integrity key indicated by the key information.

20. The method of claim 13, wherein the integrity key includes a group temporal key used for a frame integrity, and the PN is maintained for each integrity key.

21. The method of claim 13, wherein the first MIC is generated based on an Additional Authentication Data (AAD) which is constructed from a header of the BlockAck frame, the header for constructing the AAD including a Frame Control filed, a receiver address field and a transmitter address field.

22. A device for a wireless local area network, the device comprising:
a processor; and
a memory operatively coupled with the processor and configured to store instructions that, when executed by the processor, cause the device to perform functions comprising:
transmitting a data frame to a receiving station;
in response to the data frame, receiving a BlockAck frame for acknowledging the data frame from the receiving station, the BlockAck frame including:
a protection subfield indicating that the BlockAck frame is protected,
key information indicating an integrity key,
packet number (PN) information used to determine a PN corresponding to the integrity key indicated by the key information, and
message integrity check (MIC) information indicating a first MIC calculated over the BlockAck frame;
computing a second MIC based on the BlockAck frame; and
verifying the BlockAck frame based on the first MIC and the second MIC.

23. The device of claim 22, wherein the data frame includes padding bits to guarantee a processing delay time during which the receiving station generates the MIC to protect the BlockAck frame.

24. The device of claim 22, wherein verifying the BlockAck frame based on the first MIC and the second MIC includes:
discarding the BlockAck frame when the first MAC does not match with the second MIC.

25. The device of claim 22, wherein the protection subfield in the BlockAck frame is set to 1 when the protection subfield indicates that the BlockAck frame is protected.

26. The device of claim 22, wherein the protection subfield is present in a BlockAck control field in the BlockAck frame, and the PN information and the MIC information are carried in between the BlockAck control field and a frame check sequence (FCS) field of the BlockAck frame.

27. The device of claim 22, wherein the PN information and the MIC information are not present in the trigger frame when the protection present subfield in the trigger frame does not indicate that the trigger frame is protected.

28. The device of claim 22, wherein the second MIC is computed over the BlockAck frame based on the integrity key indicated by the key information.

29. The device of claim 22, wherein the integrity key includes a group temporal key used for a frame integrity, and the PN is maintained for each integrity key.

30. The device of claim 22, wherein the first MIC is generated based on an Additional Authentication Data (AAD) which is constructed from a header of the BlockAck frame, the header for constructing the AAD including a Frame Control filed, a receiver address field and a transmitter address field.
